(19) United States
(12) Patent Application Publication
(10) Pub. No.: US 2005/0079332 A1
(43) Pub. Date: Apr. 14, 2005

(54) Laminated medical examination paper

(76) Inventors: Tim Bauer, Appleton, WI (US); Lou Ann Mueller, Little Chute, WI (US)

Correspondence Address: Philip M. Weiss;Weiss & Weiss, Suite 201, 310 Old Country Road, Garden City, NY, 11530, US

(21) Appl. No.: 10/962,857

(22) Filed: Oct. 12, 2004

Related U.S. Application Data
(60) Provisional application No. 60/509,880, filed on Oct. 9, 2003.

(51) Int. Cl. B32B 31/00

(52) U.S. Cl. 428/211.1; 156/209; 156/280

(57) ABSTRACT

A laminated medical examination paper for use in a doctor's office or other medical or health care delivery setting.

### RELATED APPLICATIONS

The present application claims priority to provisional patent application Ser. No. 60/509,880, filed Oct. 9, 2003.

### FIELD OF THE INVENTION

The present invention relates to laminated medical examination paper for use in a doctor's office or other medical or health care delivery setting.

### BACKGROUND OF THE INVENTION

Traditional papers used for covering medical examination tables in a doctor's office or other health care setting are made of a single sheet of thin bleached or white tissue or other paper which may or may not be printed. These papers are dispensed in the doctor's office on a roll that covers the medical examination surface; the used portion of the roll covering the table is then torn off, and a new covering for the examination surface is dispensed from the roll. These medical examination papers are generally not sterile and have limited absorbency for moisture or bodily fluids. They are merely a short-term covering for the medical examination surface intended to provide a semi-clean surface for each successive patient who uses the examination surface.

### SUMMARY OF THE INVENTION

The present invention relates to medical examination paper comprised of a lamination of paper/polymer/paper. It is an object of the present invention for the paper to be printed with company logos, prescription drug information, or other specific advertising or medical information. One object of the present invention is to provide a printed medical examination paper that provides a smooth surface for printing, advertising or marketing information. Another object of the present invention is to provide a medical examination paper that provides an enhanced surface with respect to moisture absorption and comfort for the patient. It is an object of the present invention to provide a barrier to moisture to prevent the transfer of bodily fluids to the underlying medical examination surface, thus maintaining a more sanitary environment. Another object of the present invention is for the laminated product to be formed together in a repeated embossed pattern that results in a quilted surface with enhanced moisture absorption qualities. A further object of the invention is to provide a coated product that provides anti-bacterial properties. It is an object of the present invention for the medical examination paper to be dispensed in rolls to fit the surfaces of medical examination tables.

It is an object of the present invention for both of the papers to be comprised of kraft paper of any color. It is an object of the present invention for one sheet of paper to be kraft paper and the other sheet of paper to be non-woven paper. It is an object of the present invention for one sheet of paper to be kraft paper and the other sheet of paper to be tissue paper. It is an object of the present invention for the sheets of paper to be white.

It is an object of the present invention for only the sheet of paper which faces the person to be printed on. It is an object of the present invention for the polymer to act as both a barrier to moisture and an adhesive.

### DETAILED DESCRIPTION OF THE INVENTION

The present invention relates to a medical examination paper that is comprised of a paper/polymer/paper lamination that is formed together in an embossed quilted pattern. The invention comprises a lamination of paper/polymer/paper that is passed through an embossed nip roll or other similar equipment to form a repeated quilted pattern over the surface of the laminated product.

In one embodiment, a sheet of kraft paper with a basis weight of about 8-20 lbs. per 3,000 sq. ft. is laminated to another sheet of paper comprising kraft paper, non-woven paper or tissue with a basis weight of about 8-20 lbs. per 3,000 sq. ft. using about 4-15 lbs. of low density polyethylene or other polymer and then embossed in a quilted pattern, or repeated logo that repeats across the entire surface of the laminated product. The sheet of paper which comprises kraft paper, non woven paper or tissue paper can be printed on. Prior to or after the lamination process, one of the sheets may be printed with a design presenting marketing information, company logos, or other medical or marketing information targeted to the patient audience that uses the medical examination paper.

In an embodiment, the medical examination paper is dispensed in rolls to fit the surfaces of medical examination tables used in doctor's offices or other health care delivery settings.

The embossed quilted pattern of the present invention provides both added comfort to the patient who uses the medical examination surface as well as enhanced moisture absorption and barrier characteristics.

In an embodiment, the medical examination paper is coated or otherwise applied with a material or coating that provides anti-bacterial or anti-microbial properties to the paper.

1. A medical examination paper comprised of a lamination of paper/polymer/paper.

2. The examination paper of claim 1 wherein one of said papers is printed with company logos, prescription drug information, or other specific advertising or medical information.

3. The examination paper of claim 1 wherein said paper provides a smooth surface for printing, advertising or marketing information.

4. The examination paper of claim 1 wherein said examination paper provides an enhanced surface with respect to moisture absorption and comfort for a patient.

5. The examination paper of claim 1 wherein said examination paper provides a barrier to moisture to prevent transfer of bodily fluids to an underlying medical examination surface.

6. The examination paper of claim 1 wherein said examination paper is formed together in a repeated embossed pattern that results in a quilted surface.

7. The examination paper of claim 1 wherein said examination paper is dispensed in rolls to fit surfaces of medical examination tables.

8. The examination paper of claim 1 wherein said examination paper is coated or covered with a material or coating that provides anti-bacterial or anti-microbial properties to said paper.

9. The medical examination paper of claim 1 wherein said examination paper comprises:
a sheet of paper with a basis weight of about 8-20 lbs. per 3,000 sq. ft. laminated to another sheet of paper with a basis weight of about 8-20 lbs. per 3,000 sq. ft. using about 4-15 lbs. of a polymer resin.

10. The examination paper of claim 9 wherein said paper sheets are white.

11. The examination paper of claim 9 wherein the polymer resin comprises low density polyethylene.

12. The examination paper of claim 9 wherein said paper sheets comprise kraft paper.

13. The examination paper of claim 9 wherein said sheet of paper comprises kraft paper and said another sheet of paper comprises non-woven paper.

14. The examination paper of claim 9 wherein said sheet of paper comprises kraft paper and said another sheet of paper comprises tissue paper.

15. A method for manufacturing a lamination of paper/polymer/paper for medical examination paper comprising:
passing said paper, polymer and paper through an embossed nip roll or other similar equipment;
forming a repeated quilted pattern over a surface of said laminated product.

16. The method of claim 15 further comprising:
printing a design on said paper presenting marketing information, company logos or
other medical or marketing information prior to or after said lamination process.

17. The method of claim 15 further comprising:
passing the product through an extruder or similar equipment to coat or apply material that provides anti-bacterial or anti-microbial properties to said product.
